(19) United States
(12) Patent Application Publication
(10) Pub. No.: US 2023/0068292 A1
(43) Pub. Date: Mar. 2, 2023

(54) HISTORY APP WITH PUSHED EVENT AND LOCATION INFORMATION

(71) Applicant: Historik LLC, Coeur d'Alene, ID (US)

(72) Inventor: CHRISTOPHER Lee WHALEN, Coeur D'Alene, ID (US)

(73) Assignee: Historik LLC, Coeur D'Alene, ID (US)

(21) Appl. No.: 17/821,170

(22) Filed: Aug. 21, 2022

Related U.S. Application Data
(60) Provisional application No. 63/260,535, filed on Aug. 24, 2021.

(51) Int. Cl. G01C 21/00; G06F 16/587; G06F 16/29; H04L 67/55

(52) U.S. Cl. CPC G01C 21/3863; G06F 16/587; G06F 16/29; H04L 67/55

(57) ABSTRACT

A system is disclosed for providing a history app. The system may have a source of information regarding artifacts at historical locations, and a user portal. The user portal may have at least one of a locating device and a positional sensor to generate at least one signal, and a camera to capture a view in an environment. The system may further include a network interface and a central processing unit in communication with the source and the user portal via the network interface. The central processing unit may be configured to provide a graphical user interface for display on the user portal and, responsive to input from a user, show the view captured by the camera on the graphical user interface and an image of at least one of the artifacts within the view based on a corresponding one of the historical locations and the at least one signal.

### RELATED APPLICATIONS

This application is based on and claims the benefit of priority from U.S. Provisional Application No. 63/260,535 that was filed on Aug. 24, 2021, the contents of all of which are expressly incorporated herein by reference.

### TECHNICAL FIELD

The present disclosure relates generally to an app (i.e., a downloadable self-contained software application) for use on a mobile device and/or with the web on a desktop application. More particularly, the present disclosure relates to a system for providing a history app that allows the discovery of user-filtered historic information and simultaneously pushes to or otherwise allows sharing of event-related information within a mobile and/or handheld environment. Additionally, the disclosed system may support augmented reality, which provides contextual data and/or images about specific events, locations, and/or people.

### BACKGROUND

An app is an abbreviated term for a “software application”, which is downloadable to and executable by a mobile device (e.g., a laptop, a smart phone, or a tablet). Conventional apps are used for general business purposes, such as scheduling, address booking, emailing, shopping, etc. As mobile devices have increased in popularity and functionality, while also decreasing in cost, apps directed to educating, recreating, and socializing have become available to the public.

Apps have been developed to relay historic information to a user. Exemplary history-related apps include The Clio hosted by a non-profit organization, History Here hosted by the History Channel, and Autio founded by the actor Kevin Costner. Although enjoyable by some, existing apps may lack historical depth or focus only on known historical institutions (e.g., museums). Existing apps may not have the ability to alert a user about little known history, push information to the user, filter information based on a user's preference, or provide much in the way of an interactive experience.

The app and system of the present disclosure are directed at solving one or more of the problems set forth above and/or other issues in the art.

### SUMMARY

In one aspect, the present disclosure is directed to a system for providing a history app. The system may have a source of information regarding artifacts at historical locations, and a user portal. The user portal may have at least one of a locating device and a positional sensor configured to generate at least one signal, and a camera configured to capture a view in an environment around the user portal. The system may further include a network interface and a central processing unit in communication with the source of information and the user portal via the network interface. The central processing unit may be configured to provide a graphical user interface for display on the user portal and, responsive to input from a user, show the view captured by the camera on the graphical user interface and an image of at least one of the artifacts within the view based on a corresponding one of the historical locations and the at least one signal.

In another aspect, the present disclosure is directed to a method of providing a history app. The method may include receiving information regarding artifacts at historical locations, generating a signal indicative of at least one of a location and a position of a user portal, and capturing a view in an environment around the user portal. The method may also include, responsive to input from a user, showing the view on a graphical user interface and an image of at least one of the artifacts within the view based on a corresponding one of the historical locations and the signal.

In yet another aspect, the present disclosure is directed to a non-transitory computer readable medium containing computer-executable programming instructions for performing a method of providing a history app. The method may include receiving information regarding artifacts at historical locations, generating a signal indicative of at least one of a location and a position of a user portal, and capturing a view in an environment around the user portal. The method may also include, responsive to input from a user, showing the view on a graphical user interface and an image of at least one of the artifacts within the view based on a corresponding one of the historical locations and the signal.

### BRIEF DESCRIPTION OF THE DRAWING

FIG. 1 is a diagrammatic illustration of an exemplary disclosed computing system;

FIGS. 2, 8, 10, 11, 14 and 24 are flowcharts depicting exemplary operations that may be performed by the computing system of FIG. 1;

FIGS. 3, 4, 5, 6, 7, 9, 12, 13, 15, 16, 17, 18, 19, 20, 21, 22 and 23 are diagrammatic illustrations of exemplary disclosed graphical user interfaces that may be generated by and/or used to access the computing system of FIG. 1; and

FIG. 25 is a chart depicting an exemplary disclosed process the computing system of FIG. 1 may utilize to produce the graphical user interface of FIG. 23.

### DETAILED DESCRIPTION

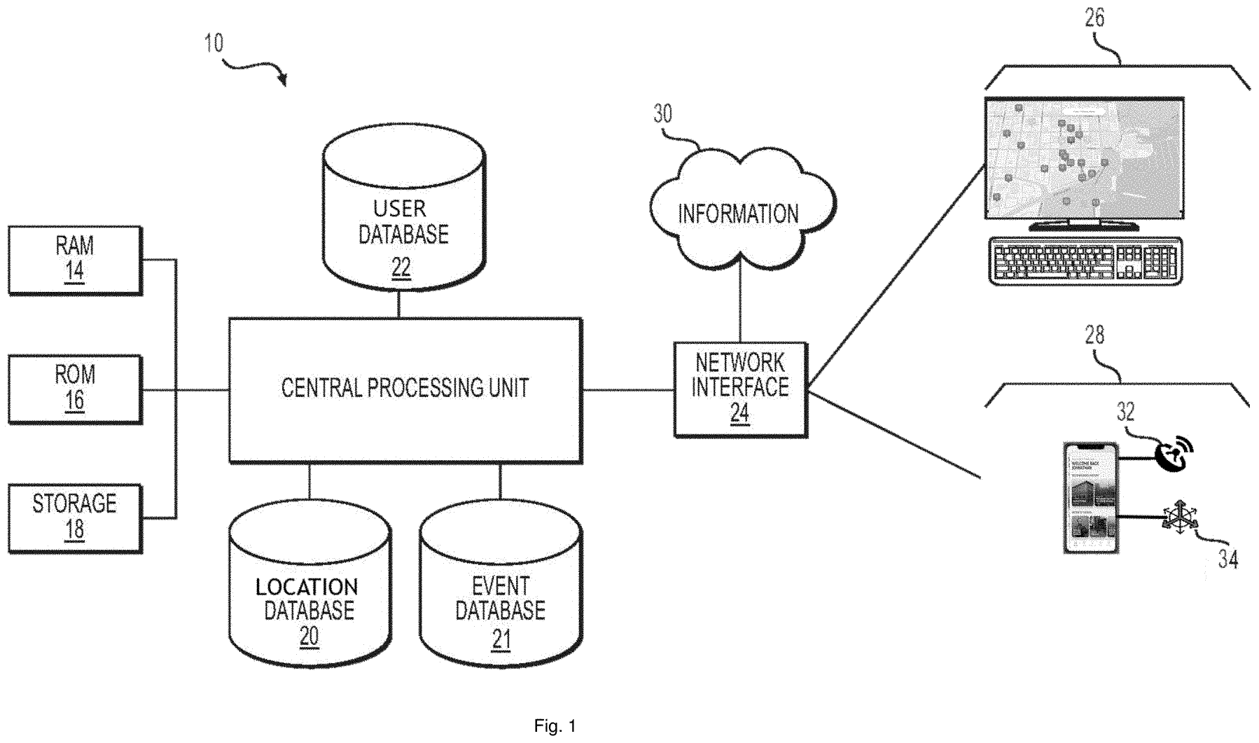

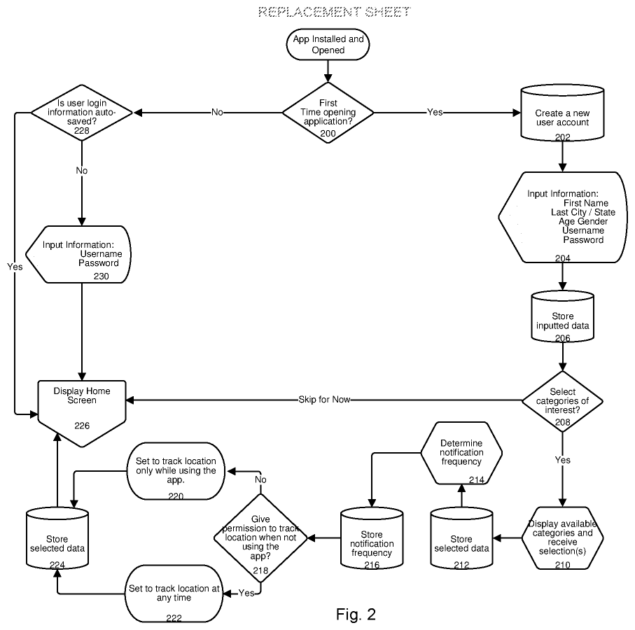

FIG. 1 illustrates an exemplary system 10 that generates, maintains, sends, displays, receives and/or records information associated with the disclosed concepts. System 10 may include, for example, a central processing unit (CPU) 12, a random access memory (RAM) 14, a read-only memory (ROM) 16, a storage 18, at least one database (e.g., a location database 20, an event database 21, a user database 22, etc.), a network interface 24, and at least one user portal (e.g., a desktop portal 26 and/or a mobile portal 28). It is contemplated that system 10 may include additional, fewer, and/or different components than those listed above. It is understood that the type and number of listed devices are exemplary only and not intended to be limiting.

CPU 12 may include an arrangement of electronic circuitry configured to perform arithmetic, logic, input/output, and control operations during sequential execution of pre-programmed instructions. The instructions may be loaded from ROM 16 into RAM 14 for execution by CPU 12. It should be noted that, although CPU 12 is shown and described as a single “unit”, it is contemplated that the functions of CPU 12 could be completed by any number of co-located or remotely distributed and cooperating processing units, as desired. Numerous commercially available microprocessors may be configured to perform the functions of CPU 12. Further, the microprocessors may be general-purpose processors or specially constructed for use in implementing the disclosed concepts.

Storage 18 may embody any appropriate type of mass storage provided to hold information that CPU 12 may need in order to perform the disclosed processes. For example, storage 18 may include one or more hard disk devices, optical disk devices, or other storage devices that provide sufficient storage space.

Databases 20-22 may contain model data and any information relating to locations, historical records, events (e.g., past, present, and/or future events), and/or users under analysis. The information stored within databases 20-22 may come from any source 30 known in the art and be provided at any time and frequency. For example, the information could be manually entered based on recorded statistics and/or live observations, automatically retrieved from an external server based on a predetermined schedule, continuously streamed from a supplier site, spontaneously uploaded by users, intermittently pulled from “the cloud,” or obtained in any other manner at any other time and frequency. In addition to the location, records, and/or event information, databases 20 and/or 22 may also include analysis tools for analyzing the information stored therein. CPU 12 may use databases 20-22 to determine relationships and/or trends relating to particular locations, records, events, users, and/or uses of system 10, and other such pieces of information. CPU 12 may pull information from databases 20-22, manipulate the information, and analyze the information. CPU 12 may also update the information, store new information, and store analysis results within databases 20-22, as desired.

CPU 12 may communicate with a user of system 10 (e.g., a user accessing the desktop and/or mobile portals 26, 28) via network interface 24. Network interface 24 may include, alone or in any suitable combination, a telephone-based network (such as a PBX or POTS), a local area network (LAN), a wide area network (WAN), a dedicated intranet, and/or the Internet. Further, the network architecture may include any suitable combination of wired and/or wireless components. For example, the communication links may include non-proprietary links and protocols, or proprietary links and protocols based on known industry standards, such as J1939, RS-232, RP1210, RS-422, RS-485, MODBUS, CAN, SAEJ1587, Bluetooth, the Internet, an intranet, 802.11 (b, g, n, ac, or ad), or any other communication links and/or protocols known in the art.

Each of portals 26, 28 can include one or more of a router, an Ethernet bridge, a modem (e.g., a wired and/or wireless modem), or any other conventional computing components known in the art (not shown) such as a processor, input/output (I/O) ports, a storage, and a memory. The processor of each portal 26, 28 can include one or more processing devices, such as microprocessors and/or embedded controllers. The storage can include volatile or non-volatile, magnetic, semiconductor, tape, optical, removable, non-removable, or other type of computer-readable medium or computer-readable storage device. The storage can be configured to store software programs (e.g., apps) downloaded to and/or from CPU 12 via network interface 24 and/or other information that can be used to implement one or more of the disclosed processes. The memory can include one or more storage devices configured to store the downloaded information. Portals 26, 28 may be able to communicate with CPU 12, with databases 20-22, and/or directly with each other via network interface 24.

Portals 26, 28 may also provide a graphical user interface (GUI) that is configured to display information to users thereof, and that includes a means for receiving input from the user. In one embodiment, a desktop portal is a computer (e.g., a laptop or desktop computer) having a console and a keyboard/mouse. In another embodiment, an exemplary mobile portal is a smart phone or a tablet having a touchscreen display, a microphone, and/or a keyboard. Other types of portals may also be utilized. The GUI of each of portals 26, 28 may allow the user to receive (e.g., audibly, tactilely, and/or visually) information (e.g., location information, historical records, event information, and information communicated between users) from system 10, to upload information to system 10, and/or to correspond with other users of system 10. Exemplary communications between users may be written (e.g., texts), visual (e.g., icons, emoticons, pictures, artistic renderings, etc.), audible (e.g., user-recorded and/or selectable pre-recorded sounds or messages), and/or a combination of these things (e.g., video or animation), as desired.

As shown in FIG. 1, portal 28 may additionally include, in some embodiments, a locating device 32 and/or a sensor 34. As will be explained in more detail below, output from one or both of these components may help to track movement of the user and/or a position/orientation of portal 28, assist in navigation, link user-location and/or portal orientation to available information, and/or trigger display of particular content.

Locating device 32 may be configured to generate signals indicative of a geographical position of portal 28 relative to a local reference point, a coordinate system associated with environment 10, a coordinate system associated with Earth, and/or any other type of 1-D, 2-D, or 3-D coordinate system. For example, locating device 32 may embody an electronic receiver configured to communicate with satellites (not shown), or a local radio or laser transmitting system used to determine a relative geographical location of itself and/or a distance or relative orientation to a known location. Locating device 32 may receive and analyze high-frequency, low-power radio or laser signals from multiple locations to triangulate a relative geographical position and orientation. This information may then be used by an onboard controller and/or CPU 12 to update the location of portal 28 in an electronic map or database.

It is contemplated that locating device 32 may take another form, if desired. For example, locating device 32 could be or otherwise include an RFID, Barcode, QR-code, or other type of reader configured to interact with a corresponding tag located within the user's environment (e.g., at a historical location. Based on the reading of the tag (or other similar indicia), the location and/or orientation of portal 28 may be linked to the known location and/or orientation of the tag or other indicia.

Sensor 34 may be any type of sensor configured to detect an orientation of portal 28 and to generate corresponding signals. In one example, sensor 34 is a conventional 3-way acceleration detector (e.g., an accelerometer) rigidly connected to portal 28. The signals generated by sensor 34 may be used by the onboard controller and/or CPU 12 to update the orientation of portal 28 in the electronic map or database.

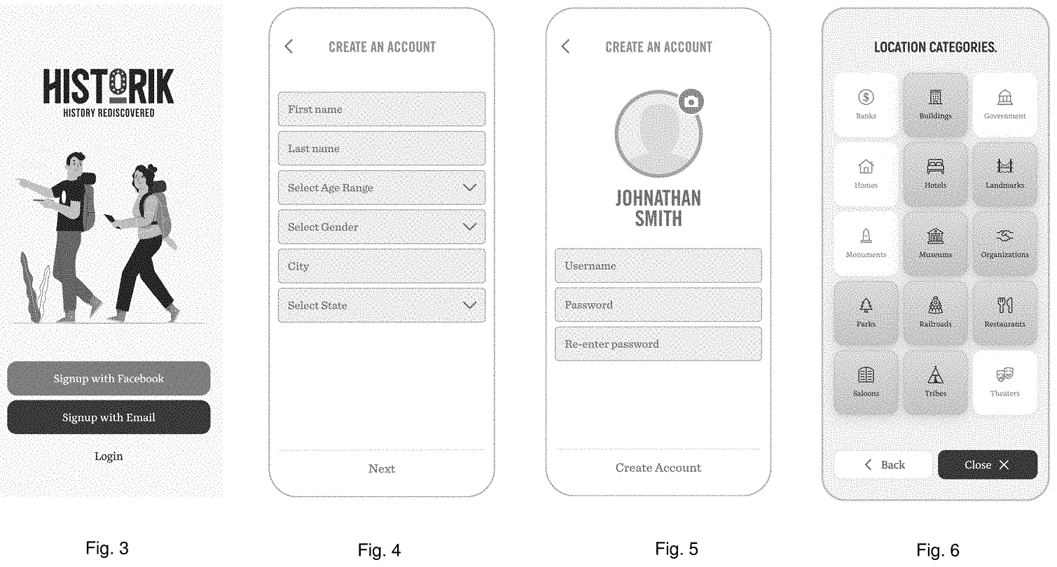

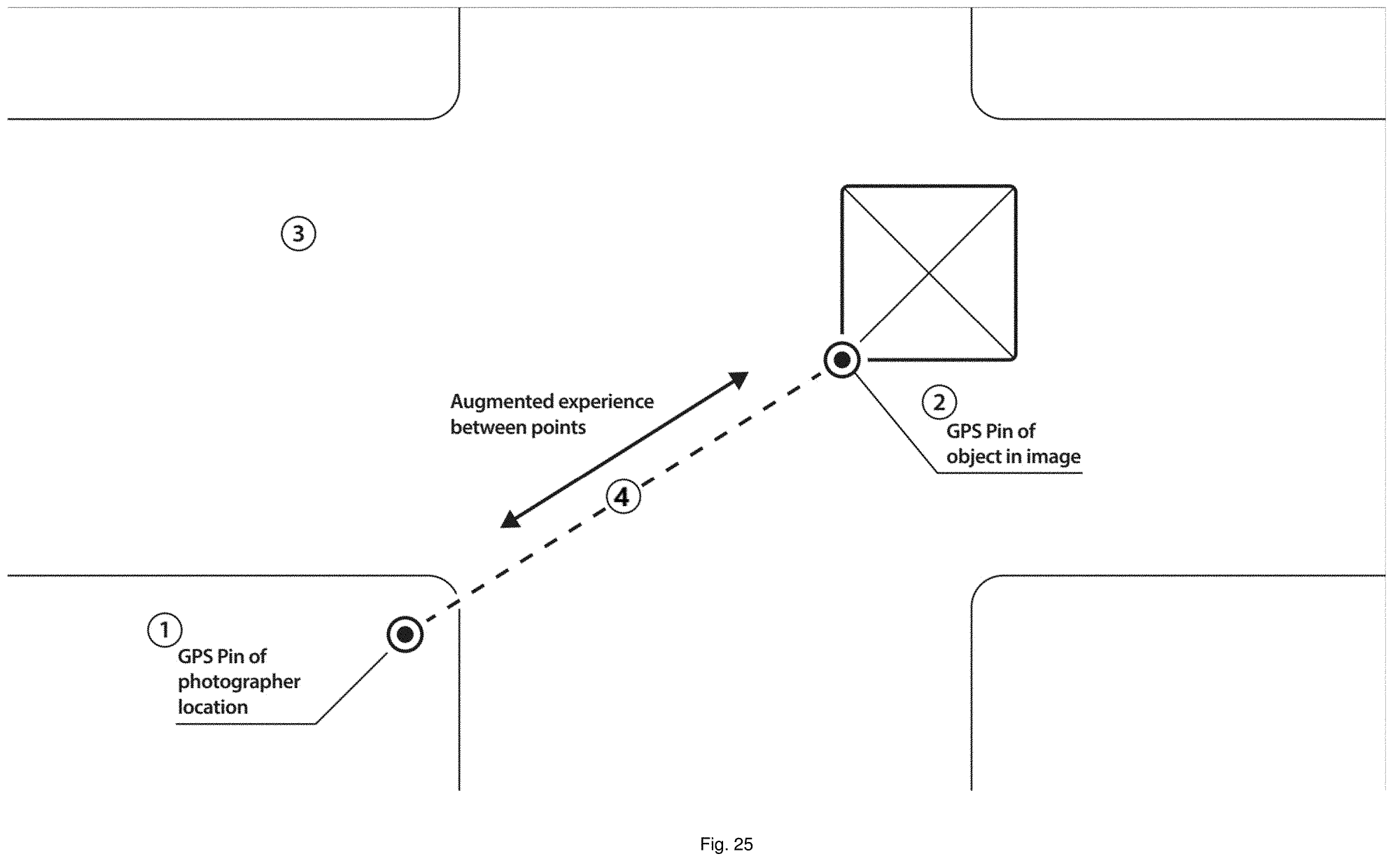

The GUIs of portals 26 and 28 may allow users to become immersed within interactive history. For example, the user may be able to download information (e.g., maps, images, facts, events, videos, etc.) about a particular location and/or filter the information based on the detected location and/or preferences of the user. The user may be able to plan trips through locations of desired historical context (e.g., content filtered based on custom selections) and/or uncover hidden history via exploration features. Historical information may be relayed visually and/or audibly to the user based on user input and/or detected vehicular travel of the user. Historical information may be selectively pushed to the user based on proximity to particular locations, and augmented reality may be available for some locations. Users may be able to network socially with each other and/or upload historical information to system 10. FIGS. 8, 10, 11, 14, and 24 are flowcharts depicting exemplary operations of system 10. FIGS. 3-7, 9, 12, 13, and 15-23 illustrate different exemplary GUIs that may be displayed on portals 26 and/or 28 during operation of system 10. FIG. 25 illustrates an exemplary process implemented by system 10. FIGS. 3-25 will be described in more detail in the following section to further illustrate the disclosed concepts.

### INDUSTRIAL APPLICABILITY

The disclosed system may be beneficial for any history enthusiast wishing to not only receive but also interact with relevant historical information. The disclosed system may also allow a user to communicate with other like-minded individuals or groups of individuals, and allow the user to create and upload content to the system for download and interaction by other users. These functions may be accessed via any of the different exemplary GUIs shown in FIGS. 3-7, 9, 12, 13, and 15-23. Operation of system 10 will now be discussed in regard to the flowcharts of FIGS. 8, 10, 11, 14, and 24 and the process chart of FIG. 25.

Upon first downloading and installing the disclosed App, CPU 12 may be programmed to determine if the App is being opened for the first time (Step 200). CPU 12 may make this determination by searching for stored credentials (e.g., credentials stored locally within portal 26 or 28) associated with the App and/or comparing the credentials to information stored within database 22. When CPU 12 determines that the user is a first-time user (Step 200—Yes), CPU 12 may display one or more of the account-related screens of FIGS. 3, 4, and/or 5 and create a new account for the user (Step 202). Creation of the new account may include prompting for and/or receiving from the user information that is unique to the user (Step 204). The unique information may include, among other things, a name, a residence location, a gender, a username, a password, a photo, etc. Each piece of this information may be manually and separately entered by the user or automatically stripped all at once from another cooperating App (e.g., from Facebook, Instagram, LinkedIn, an email account, etc.) and stored within database 21 (Step 206). In some instances, CPU 12 may prompt the user to input additional or optional information (Step 208). In one embodiment, the additional or optional information may include, among other things, a selection of various categories of historical interest.

If the user selects to provide the additional or optional information (Step 206: Yes), CPU 12 may display any number of available and predefined categories, and receive corresponding selection(s) from the user (Step 210). As shown in FIG. 6, the categories displayed on portal(s) 26 or 28 may include “Banks”, “Buildings”, “Government”, “Homes”, “Hotels”, “Monuments”, “Museums”, “Organizations”, “Parks”, “Railroads”, “Restaurants”, “Saloons”, “Tribes”, and “Theaters”. A corresponding icon may be displayed alone or together with text for each of the categories, and the user may be able select the categories via the icon and/or text (e.g., by highlighting, pressing, clicking, moving, rearranging, etc.). In addition to the selections of interest, the user may additionally be able to rank the selections based on a level of interest within each category (e.g., from 1 to 15). Any selections made by the user (and any ranking) at Step 210 may be stored, for example, within database 21 (Step 212).

In some embodiments, the disclosed App may provide for notifications to be automatically sent to the user at different times. These notifications may include, for example, a general notification that the portal being used is near a known historical location (e.g., along with a description and/or images of the location), a suggestion of another historical location further away (e.g., along with directions to the location) that the user might be interested in, and an alert when the user is near a bookmarked historical point. These notifications may be sent continuously, at default frequencies (e.g., three times per week), and/or at other frequencies defined by the user. It is contemplated that, as part of creating a new user account, CPU 12 may prompt the user to define the desired frequency of notifications or for the user to accept a default setting (Step 214). It is also contemplated that, based on a user's monitored reaction to a notification (e.g., when the user interacts with, silences, or ignores a notification), the frequency of notifications may be automatically adjusted (e.g., reduced when silenced or ignored, and increased when interacted with). The user's notification selection, if any, may be stored within database 21 (Step 216).

Some features of the disclosed App, as will be explained in more detail below, may benefit from knowing the location and/or orientation of the portal 26 or 28 that is running the App. Accordingly, as part of the new account creation, CPU 12 may request permission from the user to track the location and/or orientation that is being generated by components of the respective portal(s) (Step 218). The requested permission may include whether the location and/or orientation may be used at any time or only when the App has been opened by the user. CPU 12 may responsively set operation of the respective portal 26 or 28 based on the user's input at Step 218 (Step 220 or Step 222), and store the corresponding settings within database 21 (Step 224). Once the new user account has been created, CPU 12 may cause a Home screen to be displayed (Step 226).

Returning to Step 208, the user may have the option of skipping Steps 210-224. In this situation, control may pass directly from Step 208 to Step 226, without additional prompting or storing of data. It is contemplated that, upon a next usage of the disclosed App, CPU 12 may again prompt the user to select categories of interest and continue from aborted Step 208 through Step 224.

Returning to Step 200, when CPU 12 determines that the user is an existing user (Step 200: No), CPU 12 may prompt the portal(s) 26 or 28 being used for any previously stored login information (e.g., username and password—Step 228). When this information is available, control may pass from Step 228 to Step 226. Otherwise, CPU 12 may prompt the user to manually input the login information (Step 230) before advancing to Step 226.

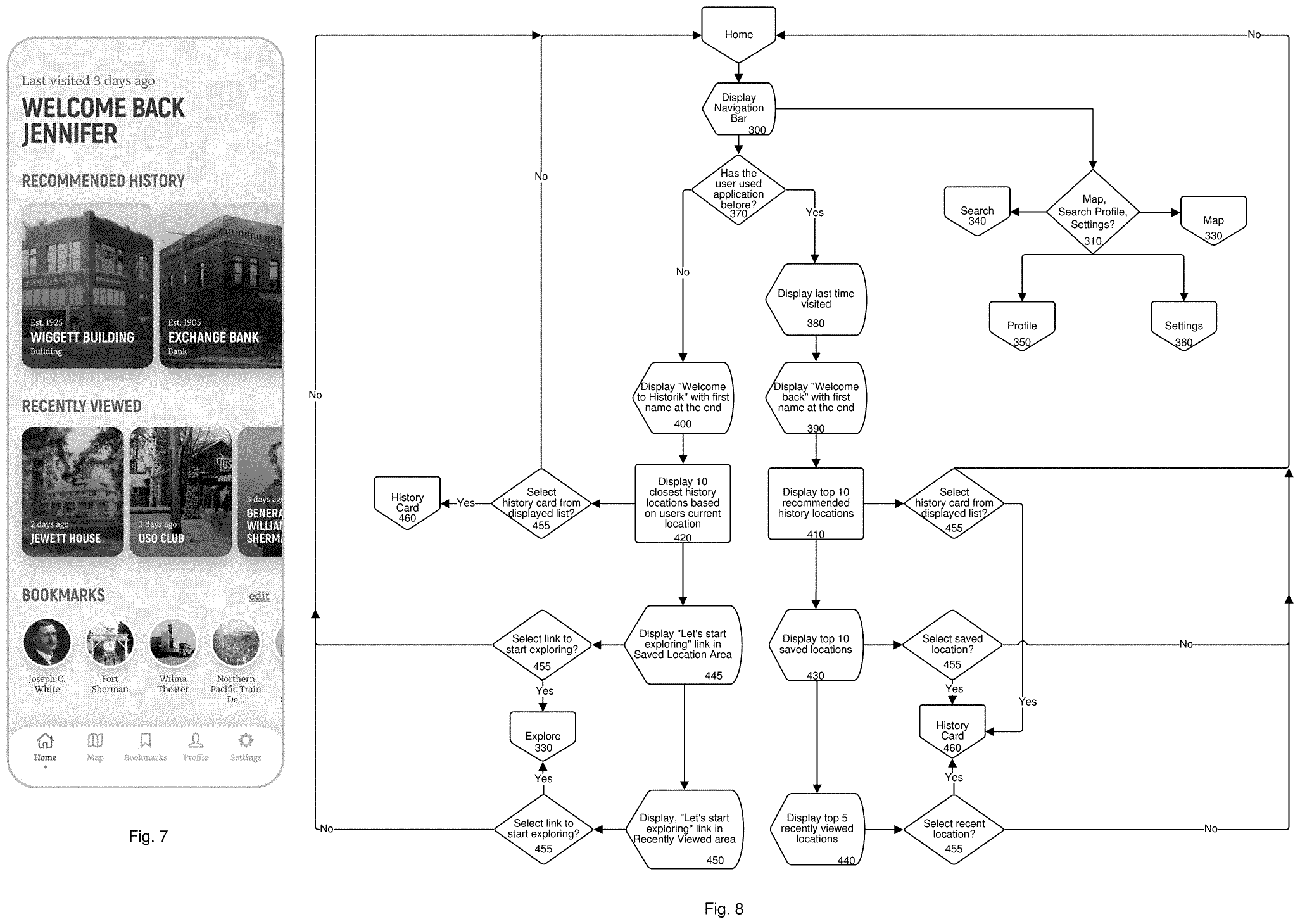

FIG. 7 illustrates an exemplary Home screen that may be displayed by CPU 12 on the portal after the user has logged into the disclosed App. As shown in FIGS. 7 and 8, displaying the home screen may include displaying multiple sections where different information and options are available. For example, CPU 12 may cause a navigation bar (e.g., shown at the lower edge of the screen) to be displayed (Step 300), from which the user can select a “Map” option, a “Search” or “Bookmark” option, a “Profile” option, or a “Settings” option (Step 310). When selecting any of these options, a corresponding screen may be displayed on the portal (Steps 330-360). As will be discussed further below, each of these available screens may include a similar navigation bar, with the additional option of returning back to the Home screen.

As shown in FIG. 7, in addition to the navigation bar, the Home screen may also include a welcome area, where the user's name can be displayed, along with a date/time of last usage of the disclosed App and/or an amount of time elapsed since last usage. In the disclosed embodiment, the welcome area may be located at an upper edge of the screen, opposite the navigation bar.

As shown in FIG. 8, when generating the welcome area of the Home screen, CPU 12 may determine if the application has been used by the logged-in user before (Step 370). If so (Step 370: Yes), CPU 12 may display information associated with the latest usage of the App by the user (Step 380), along with a welcome-back message and the user's name (Step 390). Otherwise (Step 370: No), CPU 12 may skip Step 380 and provide a welcome (e.g., welcome for the first time) message and the user's name (Step 400).

Between the welcome screen and the navigation bar, CPU 12 may cause a variety of information to be displayed to the user that is related to either the current location of the portal being used (e.g., recommended history, closest history, etc.), a recently viewed location, and/or a bookmarked (e.g., saved) location (see FIG. 7). This information may include, among other things, a name of each location, a date of establishment, a type of the location (e.g., building, landmark, etc.), a distance to the location, and/or an image or icon associated with the location.

As shown in FIG. 8, CPU 12 may selectively display recommended locations (e.g., a top 10 list—Step 410), closest locations (e.g., a top 10 list—Step 420), saved locations (e.g., a top 10 list—Step 430), and/or recently viewed locations (e.g., a top 5 list—Step 440), depending on whether the user is new or experienced with the disclosed App. When the user is new, instead of displaying saved or recently viewed locations, CPU 12 may instead display a “Let's Start Exploring” message and one or more links within the corresponding area(s) (Step 445 and 450). CPU 12 may monitor for input from the user (Steps 455) following each of Steps 410, 420, 430, 440, 445, 450, and selectively cause a history card corresponding to the selection to be displayed (Step 460) or cause the Map screen to be displayed (Step 330).

The recommended locations displayed at Step 410 may be recommended to the user based on a variety of factors. These factors may include, for example, which categories the user has enable during onboarding (e.g., at Step 208), which of the enabled categories have been visited by the user, a frequency of those visits, and/or a proximity of other locations that fall within the same or similar categories. When the user is a new or fairly new user, CPU 12 may determine which of the enabled categories have been visited the most and that are within a threshold distance of the user's current location. A list may be generated from this information and then filtered based on the frequency of past visits and/or the proximity. The top-10 entries in the list will then be made available to the user. When the user is an experienced user, CPU 12 may instead determine a top-3 categories of locations visited within the last three uses of the disclosed app and generate a list of the locations. These locations may then be ranked based on proximity, and the top-10 locations may be made available to the user.

The closest locations displayed at Step 410 may be recommended to the user based on purely on proximity. That is, based on known coordinates of historical locations that are stored in the location database 20 and signals generated by locating device 32, CPU 12 may be configured to determine a distance from the user (i.e., from the portal) to the location and rank the top-10 locations based on proximity. CPU 12 may then cause the ranked locations to be shown, starting from a closest location shown at a left-most side of the screen to a furthest away location shown at the right-most side of the screen. It is contemplated that fewer than all of the locations may be shown on the screen at a time, and that the user may need to scroll to the right to see all of the locations.

The saved locations displayed at Step 410 may also be recommended to the user based on proximity. However, in contrast to the closest locations being shown, only locations that have been previously viewed and saved by the user may be shown. These saved locations may be ranked by proximity and displayed in the same manner detailed above.

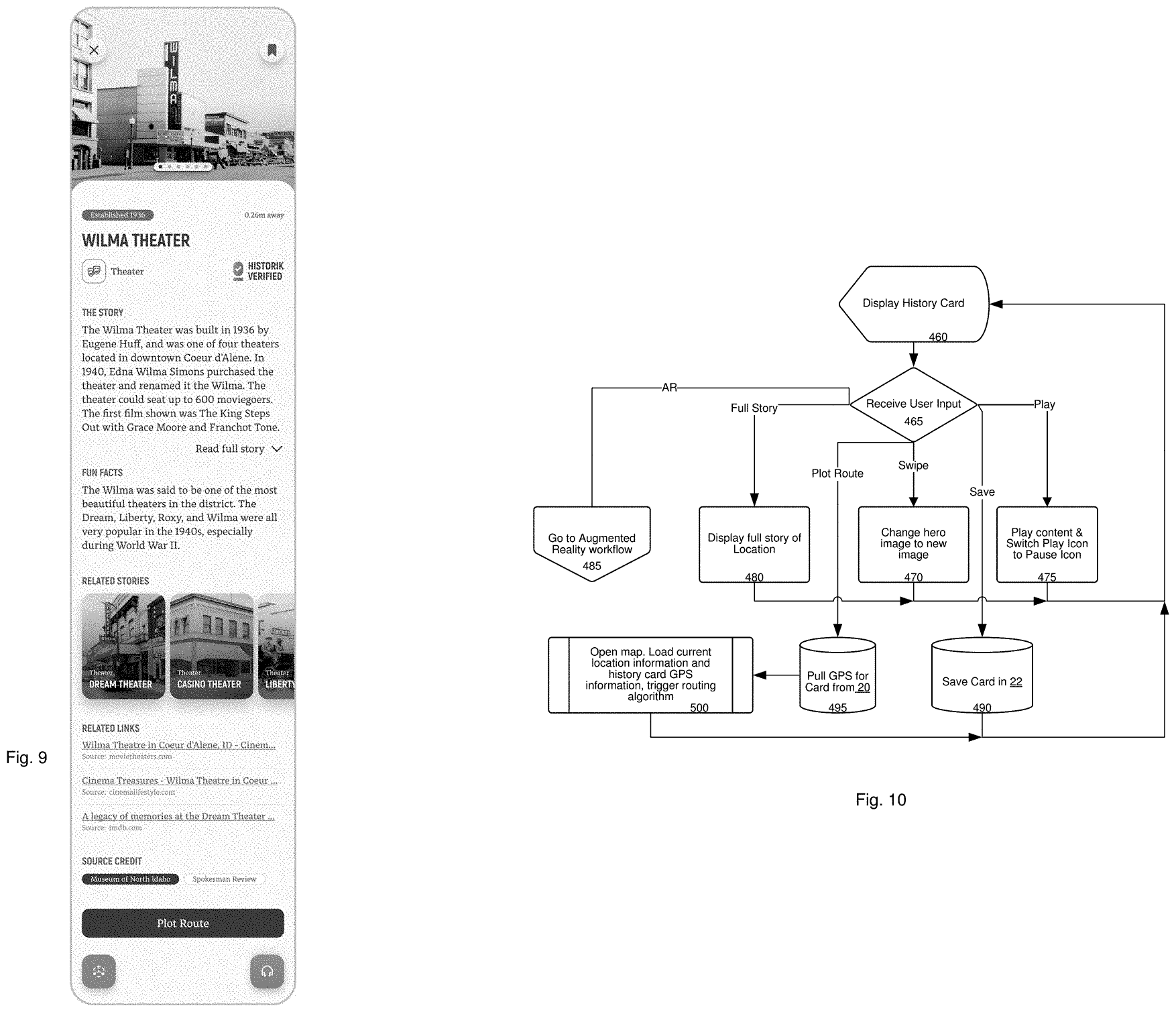

An exemplary History Card is illustrated in FIG. 9. As can be seen in this figure, each history card may include, among other things, a name of the location that is the focus of the particular card, one or more images associated with the location, a description of the location (e.g., a town/city and state), a distance that the user is away from the location, a date associated with the location (e.g., an establishment date, an engagement date, an erection date, a founding date, a birth date, a death date, or another event date), a type of the location and corresponding icon, a story about the location, a credit for where the location information is obtained, a link to additional information about the location, and options for how the user might interact with the location. When more than one image is available for the location, the user may be provided with a way to view each of the images. For example, one image may be shown enlarged (e.g., as a hero image), with other optional images (a.k.a., assets) shown in thumbnail—when a thumbnail image is selected by the user, the thumbnail may be enlarged as the hero image and the previously enlarged image may become a thumbnail asset. In some locations, video and/or audio may be available (i.e., in addition to or instead of the images), and the history card may provide a way for the user to access the video/audio (e.g., via a virtual play button).

The optional ways for a user to interact with the location corresponding to the history card may be displayed at a lower edge of the history card, opposite the location description. In the disclosed embodiment, these optional ways may include, for example, an option to view the location in augmented reality (AR), an option to plot a route from the user's current location to the historic location, and/or a way for the user to like or otherwise save the location as a favorite location.

FIG. 10 illustrates an exemplary method that CPU 12 may implement when causing a particular history card (e.g., the card shown in FIG. 9) to be displayed. As shown in FIG. 10, the first step of the method may be to cause the card to be displayed (Step 460) and to thereafter receive input from the user via interaction of the user with the various areas of the displayed card (Step 465). Based on the user input, CPU 12 may selectively cause any one of the assets to be enlarged as the hero image (Step 470), play content (visually and/or audibly) associated with the card's location (Step 475), cause more information (e.g., the full story) to be displayed (Step 480), and/or initiate an augmented reality algorithm (Step 485). Additionally or alternatively, the user may select at Step 465 to save the card as a bookmark (e.g., within database 22—Step 490) and/or to plot a route to the location of the card. When the user selects to plot a route, CPU 12 may responsively pull (e.g., from database 20) GPS information corresponding to the card's location, cause a map to be displayed that includes the GPS location and the portal's current location, and trigger a routing algorithm (Step 500). The routing algorithm may be a conventional algorithm known in the art that establishes turn-by-turn directions for moving (e.g., walking, driving, using public transportation, bicycling, etc.) from the portal's current location to the card's location.

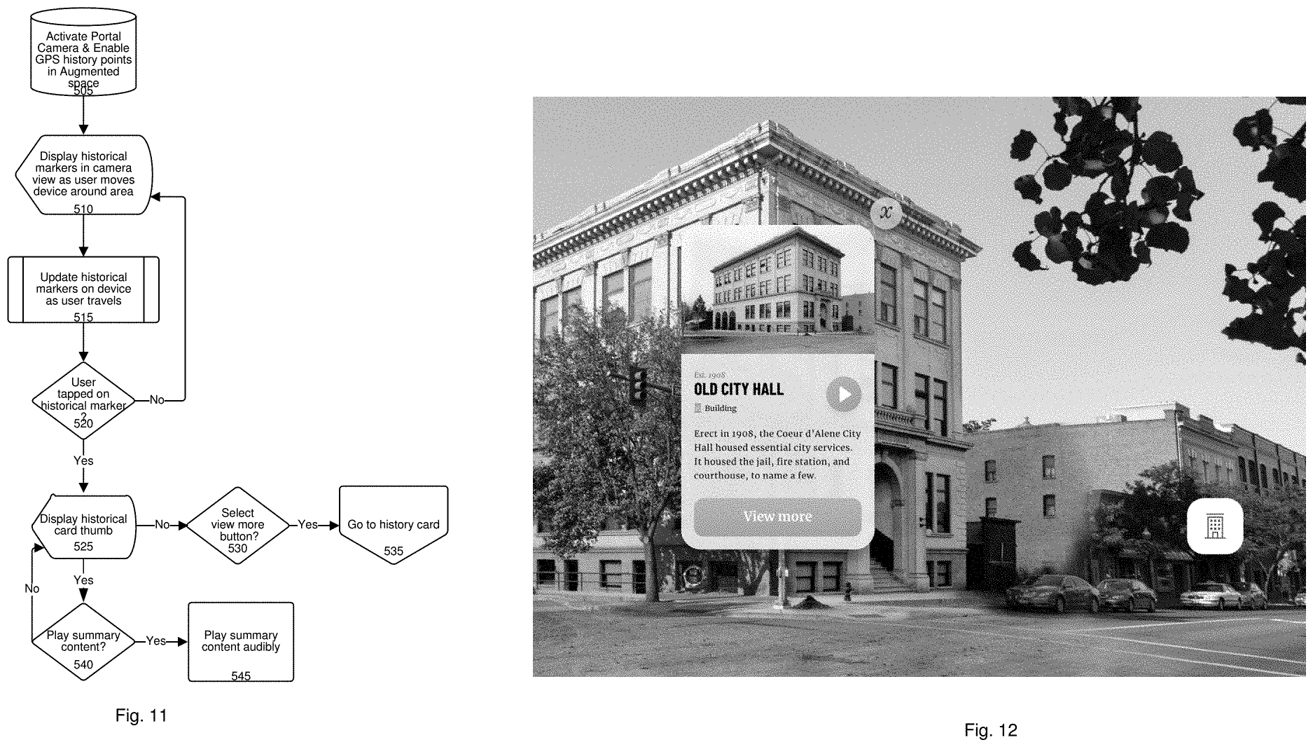

Returning to Step 485, when the user selects to activate an augmented reality experience, CPU 12 may implement the algorithm of FIG. 11 to produce the exemplary experience illustrated in FIG. 12. As shown in FIG. 11, the first step of the algorithm may include activating a peripheral device of the portal (e.g., a rear-facing camera) and enabling GPS history points associated with the particular history card (Step 505). When the history points fall within an image region (i.e., the same geospatial location, including latitude, longitude, altitude, etc.) being captured by the camera, CPU may then cause one or more markers (e.g., still images, video, symbols, icons, etc.) to be displayed at the GPS history points within the image region (Step 510). Thus, as the user moves the portal and camera around the environment, the marker(s) may become visible within the image region. This is illustrated in the example of FIG. 12, wherein a historical image (e.g., a black and white image) of an “Old Town Hall” is laid over the top of real-time image region (e.g., a color image) being captured by the camera.

In some embodiments, multiple markers of the same type and/or of the same object may be available from different perspectives. It is contemplated that, in these embodiments, CPU 12 may select only certain markers for display based on the user's position within the environment relative to the GPS history points. As the user then changes this position, CPU 12 may update which marker(s) are shown at the same GPS history point (Step 515).

At any time during the AR experience, the user may be able to tap the portal's display, and CPU 12 may receive this input (Step 520) and respond accordingly. For example, CPU 12 may cause a thumbnail of the corresponding history card to be displayed (Step 525). Thereafter, an additional tap received by CPU 12 (Step 530) may cause the full-sized history card to be displayed (e.g., CPU 12 may return the History Card Screen—Step 535). When the thumbnail of the history card is shown within the AR experience, the user may be able to play any content available in association with the history card, without having to leave the AR experience (Steps 540 and 545).

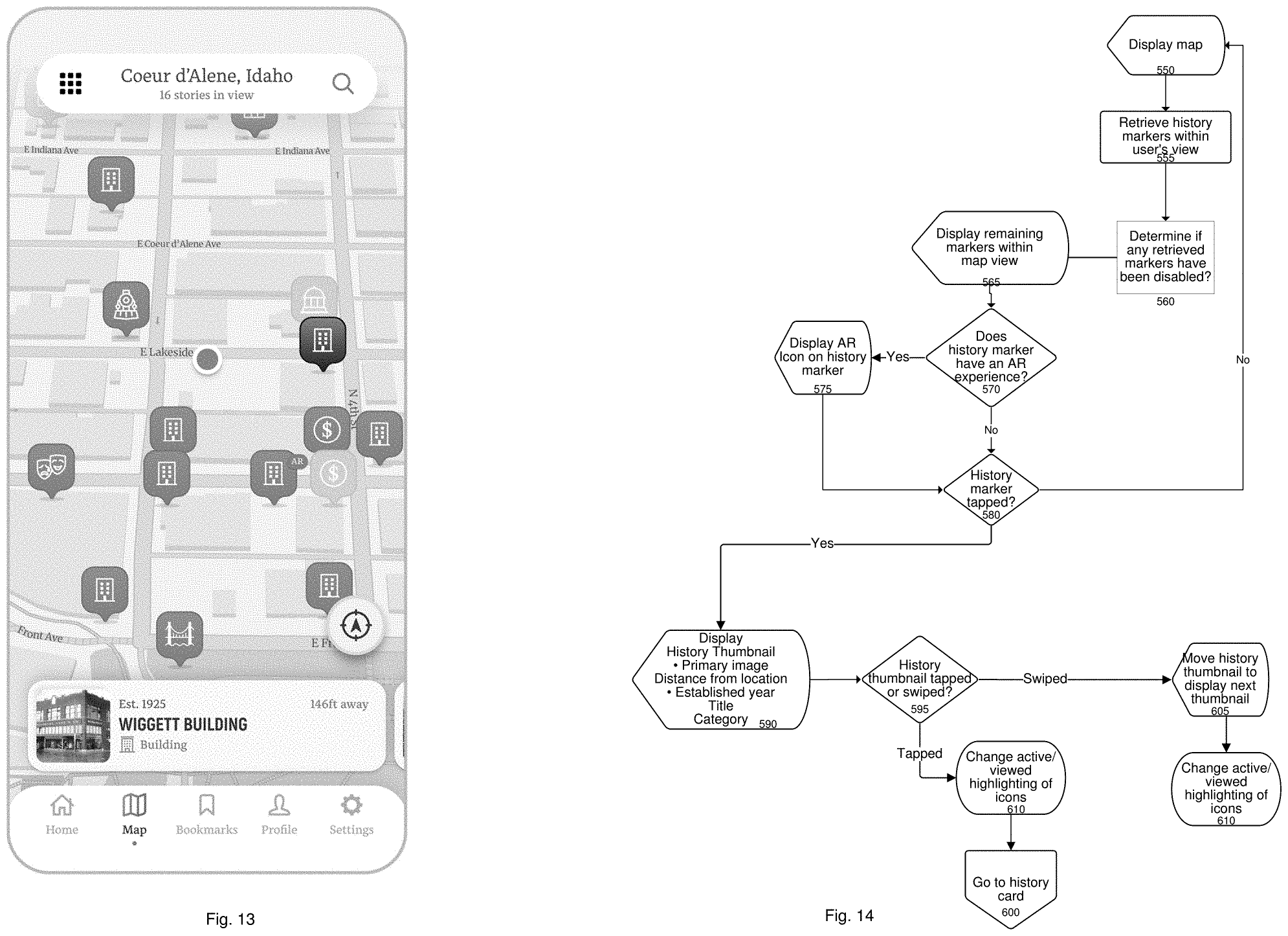

Returning to Step 310 of FIG. 8, when the user selects the Map option, CPU 12 may navigate the user to a Map screen. An exemplary Map screen is illustrated in FIG. 13. As can be seen from this figure, the Map screen may display a 2D and/or 3D map of the user's surroundings, including geographic features (e.g., streets, buildings, rivers, parks, etc.) and the user's location (e.g., marked with a colored (e.g., blue) compass needle. As discussed above, the Map screen may include the navigation bar at the bottom of the screen, and location information at a top of the screen. A search feature may be available, in some embodiments. In addition, the Map screen may display any number of historic locations at particular coordinates within the map, along with icons identifying the categories of the locations. As will be explained in more detail below, one of the icons may selectively be highlighted (e.g., with a different color, for example red) when a user selects the particular icon. When an icon has been selected, a thumbnail corresponding to the icon may be shown towards the bottom of the map (e.g., just above the navigation bar). Similarly, icons may be displayed differently (e.g., in gray) after having been viewed (e.g., after a different icon is selected for viewing).

FIG. 14 illustrates an exemplary flowchart that CPU 12 may follow during usage of the Map screen. As shown in this figure, the first step may include display of the map (Step 550). The displayed map may show the user's surroundings within a default or user-selected distance from the user's current location. It is contemplated, however, that as the user navigates through the map (e.g., by moving, by selecting features or icons, etc.), the map may re-center, zoom-in, zoom-out, rotate, and/or be adjusted in another manner. A resetting icon may be situated within the Map screen (e.g., toward the bottom of the screen, but above the thumbnail) and used by the user to return to the original view.

After causing the map to be displayed within the corresponding portal, CPU 12 may retrieve all markers having locations falling within the current view (Step 555). CPU 12 may then determine if any of the retrieved markers have been disabled by the user (e.g., via category filtering—Step 560), and cause only the remaining markers to be displayed (Step 565). Of the displayed markers, CPU 12 may then determine if any have an AR experience associated therewith (Step 570). CPU 12 may then cause the corresponding markers to be distinguished from the other markers (e.g., via application of an AR badge to the marker Step 575).

CPU 12 may then monitor user input to determine if the user has tapped one of the displayed markers (Step 580). When CPU 12 determines that the user has tapped one of the displayed markers, CPU 12 may display a thumbnail corresponding to the tapped marker (Step 590). The thumbnail may include, among other things, a primary image, a distance from the user's current location, a year of establishment, a title, and a category.

In some applications, the thumbnail itself may also be tapped and/or swiped by the user to learn additional information about the location. Accordingly, CPU 12 may monitor for thumbnail tapping and/or swiping (Step 595), and selectively navigate to the corresponding History Card (Step 600) when tapping from the user is detected or to a different thumbnail (Step 605) when swiping from the user is detected. In addition to navigating to a different thumbnail upon swiping detection, CPU 12 may adjust highlighting of the displayed icons (e.g., by changing which icon is active and which icon has been viewed—Step 610).

It is contemplated that multiple historical artifacts may be present at a given location and/or in close proximity to each other. In these situations, rather than showing icons for each of the artifacts, CPU 12 may instead show only a single icon to represent all of the agglomerated artifacts. In some applications, a number of the artifacts may be shown with the single icon to relay the number of different artifacts available at the single location. In these applications, when a user taps on the numbered icon, the map may zoom in and shown all of the artifacts as separate icons within the zoomed-in view.

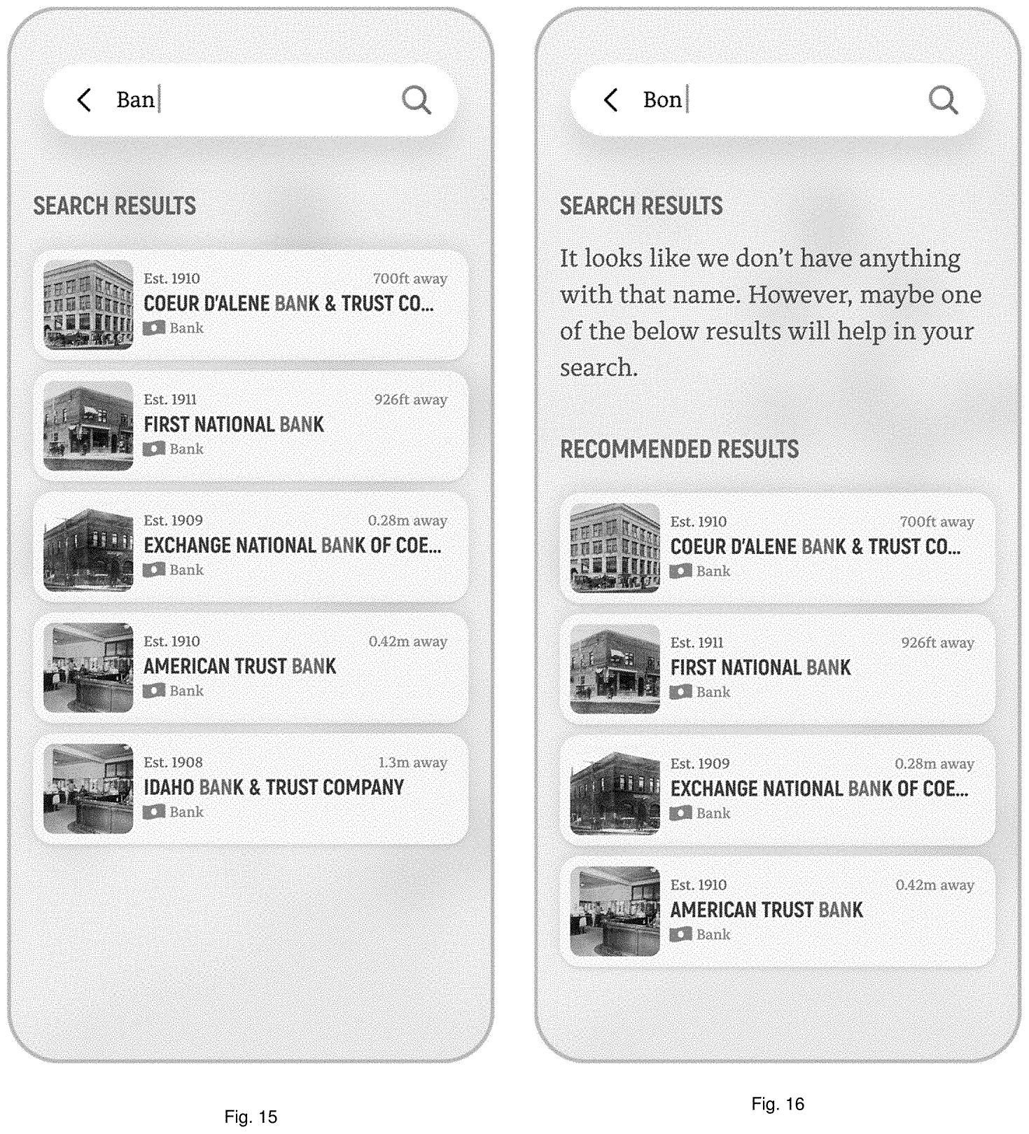

When the user selects the Search function on the navigation bar (e.g., from any screen), CPU 12 may navigate to a corresponding Search screen. Exemplary Search screens are illustrated in FIGS. 15 and 16. Using conventional keyword search algorithms, CPU 12 may selectively display icons, names, and distances to known historic locations as a user types in letters of the keywords See FIG. 15). Upon selection of one of the icons, control may navigate to the corresponding History Card. If no matches of historic locations are found for the keyed entries, CPU 12 may determine one or more historic locations with similar spelling and display options for the user to select the History Card(s) (See FIG. 16).

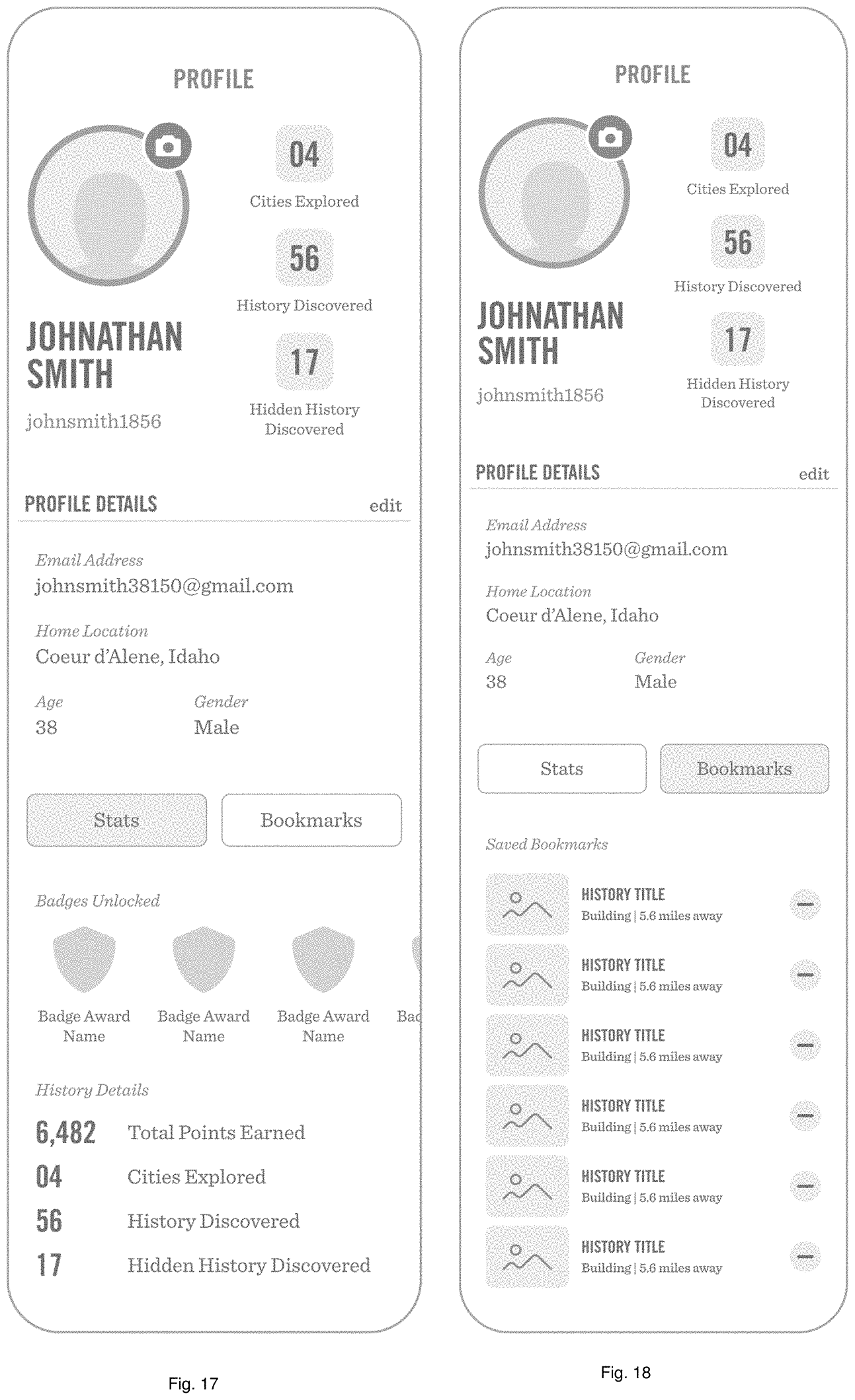

When the user selects the Profile function on the navigation bar (e.g., from any screen), CPU 12 may navigate to a corresponding Profile screen. Exemplary Profile screens are illustrated in FIGS. 17 and 18. As shown in these figures, CPU 12 may cause some or all of the information stored within database 22 in association with the user to be displayed in the Profile screen. This information may include, for example, an image of the user, contact information (e.g., email address, phone number, etc.), demographics of the user (e.g., age, gender), statistics associated with the user's use of the disclosed App (e.g., number of cities explored, number of historic locations visited, etc.), gaming facts (e.g., badges achieved, points earned, etc.), number of historic locations saved as bookmarks, etc. The user may be able to edit some of this information (e.g., the image, contact information, and/or demographics), if desired. In some embodiments, the statistics information and the bookmark information may be shown separately, for example only when the user taps corresponding virtual buttons displayed on the Profile screen. When the user taps the Bookmarks button, additional information for each saved location may be displayed and the user may select a particular bookmark to navigate to a corresponding History Card, if desired.

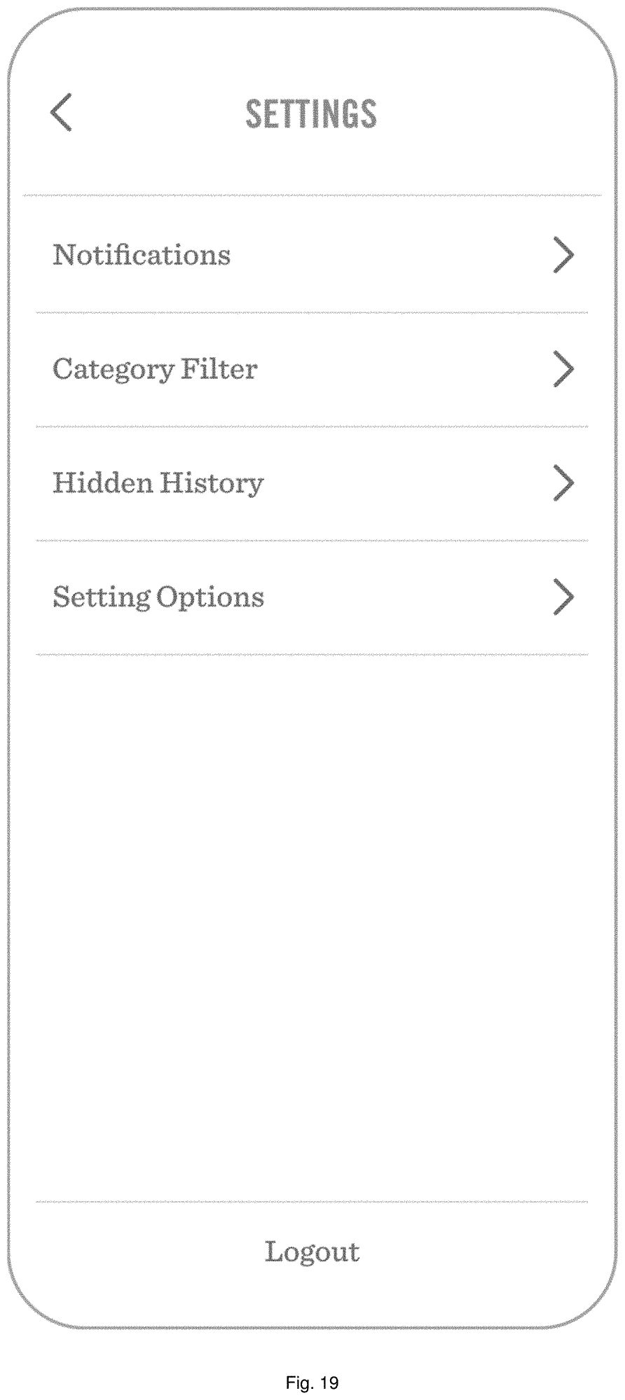

When the user selects the Settings function on the navigation bar (e.g., from any screen), CPU 12 may navigate to a corresponding Settings screen. An exemplary Settings screen is illustrated in FIG. 19. As shown in this figure, CPU 12 may display current settings for the disclosed App and/or allow the user to make and/or adjust the settings. These settings may be loosely categorized into three types, including Notifications, Category Filtering, and Options.

The Notifications may include, among other things, a desired frequency of notifications and a type of notifications that the user would like to receive. The frequency may be selected by the user to be instantly, three times per day, two times per day, once per day, or never. The types of notifications may include notifications that historic locations may be nearby (e.g., Hidden History) and notifications of suggested history (e.g., newly available historic locations and/or historic locations similar to those previously liked by the user).

The Category Filtering may include the initial filtering set as a first-time user and shown in FIG. 6. That is, at any time, the user may return to and adjust these filtering options to thereby affect the information displayed to the user via the other screens. The user may also be able to turn-on or turn-off category filtering, as desired.

The Options may include basic operational and/or display settings for the App, including, for example, font size, map dimensions/range, colors, etc.

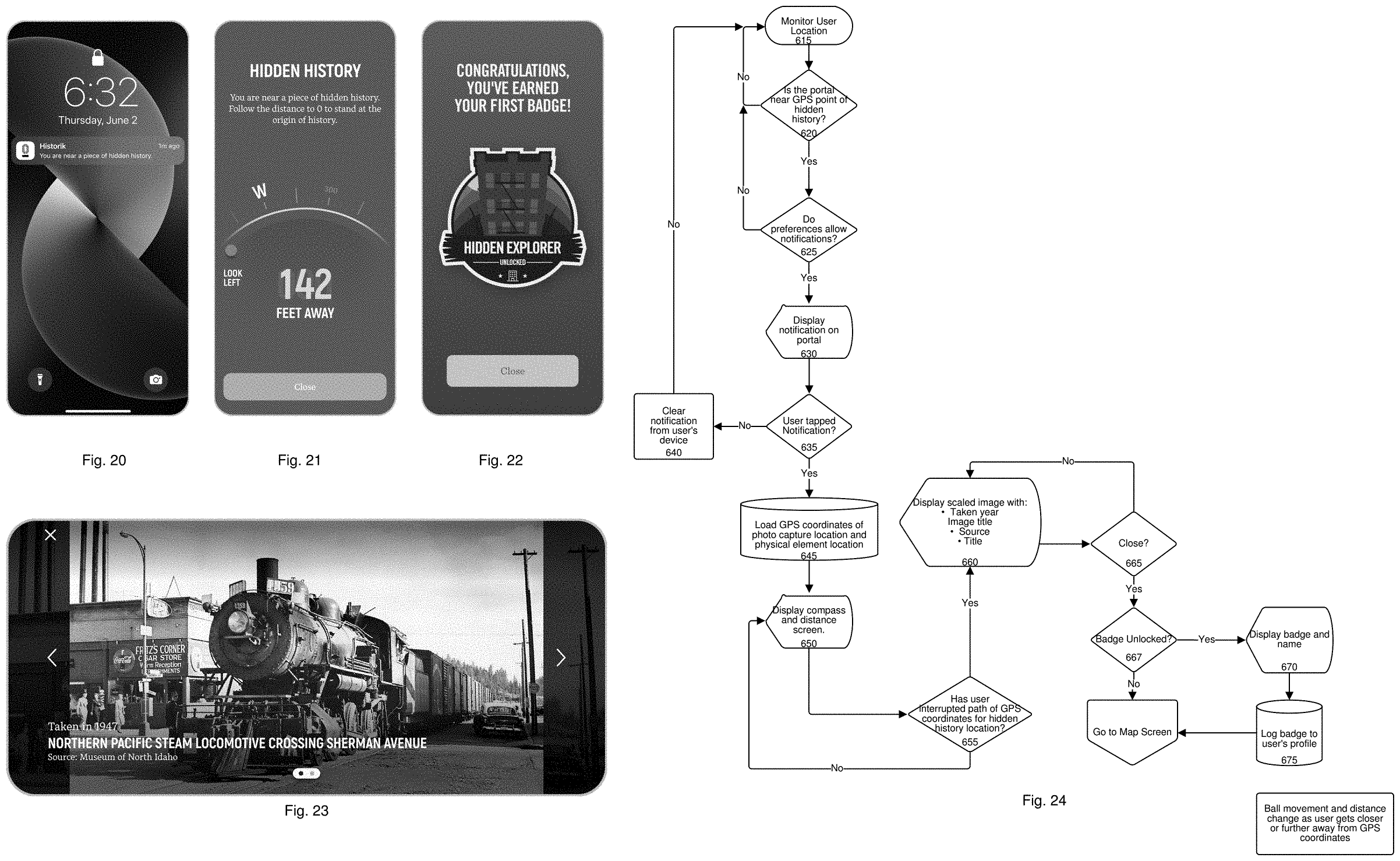

When the user chooses from the Settings screen to enable Notifications associated with Hidden History, CPU 12 may selectively implement a gaming algorithm associated with historical locations in the immediate vicinity of the user that the user is yet unaware of. In some embodiments, the Hidden History may include locations and/or information that is not otherwise available (e.g., it is hidden and only available when the user choses to engage the gamification functionality). FIGS. 20, 21, 22 and 23 illustrate exemplary screens displayed by CPU 12 when implementing the gaming algorithm shown in FIG. 24.

As seen in FIG. 24, CPU 12 may continuously monitor the location/orientation of the user's portal, when the disclosed App is enabled (Step 615). CPU 12 may compare the monitored information to GPS points of known Hidden History (Step 620) to determine if the portal is near a point of known Hidden History. When the user has selected to enable Notifications associated with Hidden History (e.g., as confirmed by CPU 12 at Step 625) and the user is near a point of known Hidden History, CPU 12 may provide a corresponding notification on the portal via the App (see FIG. 20—Step 630) and wait for the user to engage. When the user refuses to engage (e.g., as determined by CPU 12—Step 635—after a period of notification has elapsed), the notification may be cleared from the screen (Step 640) and control may return to Step 615.

However, when the user taps the notification and thereby chooses to engage with the Hidden History, CPU 12 may load GPS coordinates associated with the Hidden History into a navigation algorithm (Step 645). These coordinates may include, for example, coordinates associated with the location (e.g., location #2 shown in FIG. 25) of an object captured in an image (e.g., still image or video) and coordinates for the location (e.g., location #1 shown in FIG. 25) of the camera capturing the image. A virtual perspective or trajectory (represented as a dashed line between locations #1 and #2 in FIG. 25) may then be determined between the two locations, and CPU 12 may cause a display to be shown on the portal that directs the user from the users current location (e.g., location #3 shown in FIG. 25) to interrupt the trajectory (e.g., at location #4 shown in FIG. 25) (Step 650). As shown in FIG. 21, this display may include, among other things, a compass providing a heading to the trajectory and a distance of the portal away from the trajectory. Additional information (e.g., the city, a general location within the city, a motivational message, etc.) may also be displayed (e.g., below the compass).

As the user follows the heading, CPU 12 may responsively adjust the compass heading and distance. When CPU 12 determines that the user has reached the trajectory (e.g., at location #4) (Step 655), CPU 12 may responsively cause the screen of FIG. 23 to be shown on the portal. For example, CPU 12 may cause an image of the Hidden History to be displayed at the object location and at a scale corresponding the user's position along the trajectory (See FIG. 23) (Step 660). Additional information associated with the Hidden History (e.g., a year the image was taken, a title of the image, a source of the image, etc.) may also be shown (e.g., laid over a portion of the image).

In some situations, the user may choose to adjust their position along the trajectory, between location 1 and location 2. As the user's position changes along this trajectory, CPU 12 may be configured to make corresponding adjustments to displayed image. For example, as the user's location (e.g., location #4) approaches the object's location (e.g., location #2), the image of the object may be displayed larger within the portal in the same way that the object would have appeared to the user had the user moved in the same manner toward the object at the point in time that the image had been captured. The opposite may also be true.

When CPU 12 detects that the user has closed the image (Step 665), CPU 12 may determine if the user has unlocked a badge (Step 667) and selectively cause the image of FIG. 22 to be shown on the portal. In the disclosed embodiment, the image includes a message regarding the achievement and designation of a badge or rank associated with the achievement. The achievement may then be stored within database 22. When a badge has not been unlocked, control may return to the Map Screen.

It will be apparent to those skilled in the art that various modifications and variations can be made to the disclosed system and associated app without departing from the scope of the disclosure. Other embodiments of the system and app will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A system for providing a history app, comprising:
a source of information regarding artifacts at historical locations;
a user portal having:
at least one of a locating device and a positional sensor configured to generate at least one signal; and
a camera configured to capture a view in an environment around the user portal;
a network interface; and
a central processing unit in communication with the source of information and the user portal via the network interface, the central processing unit being configured to:
provide a graphical user interface for display on the user portal; and
responsive to input from a user, show the view captured by the camera on the graphical user interface and an image of at least one of the artifacts within the view based on a corresponding one of the historical locations and the at least one signal.

2. The system of claim 1, wherein the central processing unit is further configured to show on the graphical user interface a position of the user portal relative to the historical locations based on the at least one signal, wherein the image is shown within the view at the corresponding one of the historical locations only when the at least one signal indicates the view is within a range of coordinates of the corresponding one of the historical locations.

3. The system of claim 1, wherein the image is shown within the view at the corresponding one of the historical locations only when the at least one signal indicates a position of the user portal interrupts a trajectory between the corresponding one of the historical locations and a location from which the image of the at least one of the artifacts was originally captured.

4. The system of claim 3, wherein the central processing unit is further configured to show on the graphical user interface navigational guidance to the trajectory.

5. The system of claim 3, wherein the central processing unit is further configured to scale the image based on a location of the user portal along the trajectory.

6. The system of claim 1, wherein the information includes a notification that the user is within a threshold distance of the at least one of the artifacts.

7. The system of claim 1, wherein the central processing unit is further configured to show on the graphical user interface icons associated with the historical locations.

8. The system of claim 7, wherein the central processing unit is further configured to show on the graphical user interface a thumbnail of an artifact associated with a user-selected one of the icons.

9. The system of claim 8, wherein the central processing unit is further configured to show on the graphical user interface a dedicated screen associated with the thumbnail upon a first selection of the thumbnail by the user.

10. The system of claim 9, wherein the central processing unit is further configured to show on the graphical user interface a different thumbnail associated with a different artifact upon a second selection of the thumbnail by the user, the second selection being different than the first selection.

11. The system of claim 1, wherein the central processing unit is further configured to filter the historical locations shown on the graphical user interface based on user-selected categories of the artifacts.

12. The system of claim 1, wherein the central processing unit is further configured to recommend historical locations based on the filtering and on previous visits of the user to the historical locations.

13. A method of providing a history app, comprising:
receiving information regarding artifacts at historical locations;
generating a signal indicative of at least one of a location and a position of a user portal;
capturing a view in an environment around the user portal; and
responsive to input from a user, showing the view on a graphical user interface and an image of at least one of the artifacts within the view based on a corresponding one of the historical locations and the signal.

14. The method of claim 13, wherein showing the image includes showing the image within the view at the corresponding one of the historical locations only when the signal indicates the view is within a range of coordinates of the corresponding one of the historical locations.

15. The method of claim 13, wherein showing the image includes showing the image within the view at the corresponding one of the historical locations only when the signal indicates a position of the user portal interrupts a trajectory between the corresponding one of the historical locations and a location from which the image of the at least one of the artifacts was originally captured.

16. The method of claim 15, further including showing on the graphical user interface navigational guidance to the trajectory.

17. The method of claim 16, further including scaling the image based on a location of the user portal along the trajectory.

18. The method of claim 13, wherein the information includes a notification that the user is within a threshold distance of one of the artifacts.

19. The method of claim 18, further including:
showing on the graphical user interface icons associated with the historical locations;
showing on the graphical user interface a thumbnail of an artifact associated with a user-selected one of the icons;
showing on the graphical user interface a dedicated screen associated with the thumbnail upon a first selection of the thumbnail by the user; and
showing on the graphical user interface a different thumbnail associated with a different artifact upon a second selection of the thumbnail by the user, the second selection being different than the first selection.

20. A non-transitory computer readable medium containing computer-executable programming instructions for performing a method of providing a history app, the method comprising:
receiving information regarding artifacts at historical locations;
generating a signal indicative of at least one of a location and a position of a user portal;
capturing a view in an environment around the user portal; and
responsive to input from a user, showing the view on a graphical user interface and an image of at least one of the artifacts within the view based on a corresponding one of the historical locations and the signal.
